(19) United States
(12) Patent Application Publication
(10) Pub. No.: US 2014/0006081 A1
(43) Pub. Date: Jan. 2, 2014

(54) System, software, and method for consolidating appointment information

(71) Applicants: Stephen D David, Lawrenceville, NJ (US); Donald Hector Bragger, Hillsborough, NJ (US)

(72) Inventors: Stephen D David, Lawrenceville, NJ (US); Donald Hector Bragger, Hillsborough, NJ (US)

(21) Appl. No.: 13/862,496

(22) Filed: Apr. 15, 2013

Related U.S. Application Data
(60) Provisional application No. 61/666,943, filed on Jul. 2, 2012.

(51) Int. Cl. G06Q 10/10

(52) U.S. Cl. CPC G06Q 10/1095
USPC 705/7.19

(57) ABSTRACT

A system for consolidating appointment information comprises a machine and a program product comprising machine-readable program code for causing, when executed, the machine to perform process steps, which may include storing appointment information for a plurality of appointments, each appointment corresponding to at least one contact destination of a user, receiving a request from the user to consolidate the appointment information, sending a verification request to the user via the at least one contact destination, receiving a verification confirmation from the user regarding the at least one contact destination, receiving from the user a preference regarding appointment reminders, and reminding the user of each of the plurality of appointments according to the preference.

### REFERENCE TO RELATED APPLICATION

This application claims the benefit of U.S. Provisional Patent Application No. 61666943, filed Jul. 2, 2012, entitled, “SYSTEM AND METHOD FOR MANAGING TIME SENSITIVE TASKS.”

### BACKGROUND OF THE INVENTION

The present invention relates to a method of retrieving, displaying details of, and obtaining confirmation for appointments held by an individual with heterogeneous service providers.

People with appointments often forget to honor them, which results in lost revenue for the businesses with whom these appointments were made. Phone, e-mail, and text reminders are limited in their own ways, including convenience of retrieving the message, including lack of organization of information of appointments with multiple providers, means by which appointment-related information is communicated, ability of the application to interact with its users, and other problems.

Phone reminders are synchronous, meaning the person must answer the call when it comes in if any response is to be given. E-mail reminders are typically not optimized for mobile viewing, and many service providers do not collect e-mail addresses which prevent this type of communication. Text reminders often cost the recipient something to receive, and are limited in the information it can deliver and degree of interactivity they provide. All methods lack robust organization of appointment information, in particular when across multiple providers. All of the methods mentioned also have security concerns to varying degrees.

Mobile applications are an increasingly preferred means of consumers interacting with businesses. Appointment reminders via mobile apps allow for a more convenient, secure, media-rich, interactive way of communicating appointment information between service provider and consumer than do phone, text, and e-mail reminders.

As can be seen, there is a need for solutions to these and other problems.

### SUMMARY OF THE INVENTION

In one aspect of the present invention, a system for consolidating appointment information comprises: a machine; and a program product comprising machine-readable program code for causing, when executed, the machine to perform the following process steps: storing appointment information for a plurality of appointments, each appointment corresponding to at least one contact destination of a user; receiving a request from the user to consolidate the appointment information; sending a verification request to the user via the at least one contact destination; receiving a verification confirmation from the user regarding the at least one contact destination; receiving from the user a preference regarding appointment reminders; and reminding the user of each of the plurality of appointments according to the preference.

In one aspect, the system further comprises a mobile device connected via a wireless network to the machine. In one aspect, the mobile device is configured to display reminders of the plurality of appointments according to the preference. In one aspect, the mobile device is configured to display a plurality of possible preferences from which the user may select the preference.

In one aspect, the program code further causes the machine to store appointment information for a plurality of appointments for a plurality of users. In one aspect, the program code further causes the machine to receive a reschedule request from the user. In one aspect, the program code further causes the machine to receive an appointment confirmation from the user. In one aspect, the at least one contact destination of the user comprises a phone number. In one aspect, the at least one contact destination of the user comprises an email address.

In one aspect, at least one appointment corresponds to a first contact destination of the user, the first contact destination comprising a phone number, and wherein at least one appointment corresponds to a second contact destination of the user, the second contact destination comprising an email address. In one aspect, the program code further causes the machine to consolidate the appointment information, whereby the reminding comprises reminding the user of each of the plurality of appointments according to the preference and irrespective of to which contact destination each appointment corresponds. In one aspect, the appointment information comprises information authorized by the user regarding dates and times of meetings with other people. In one aspect, the preference comprises a preference for being reminded via text message. In one aspect, the preference comprises a preference for being reminded via phone call.

These and other features, aspects and advantages of the present invention will become better understood with reference to the following drawings, description and claims.

### BRIEF DESCRIPTION OF THE DRAWINGS

FIG. 1: is a front view of an embodiment of the present invention shown in use.

FIG. 2: is a flowchart according to one embodiment of the present invention.

FIG. 3: is a flowchart according to one embodiment of the present invention.

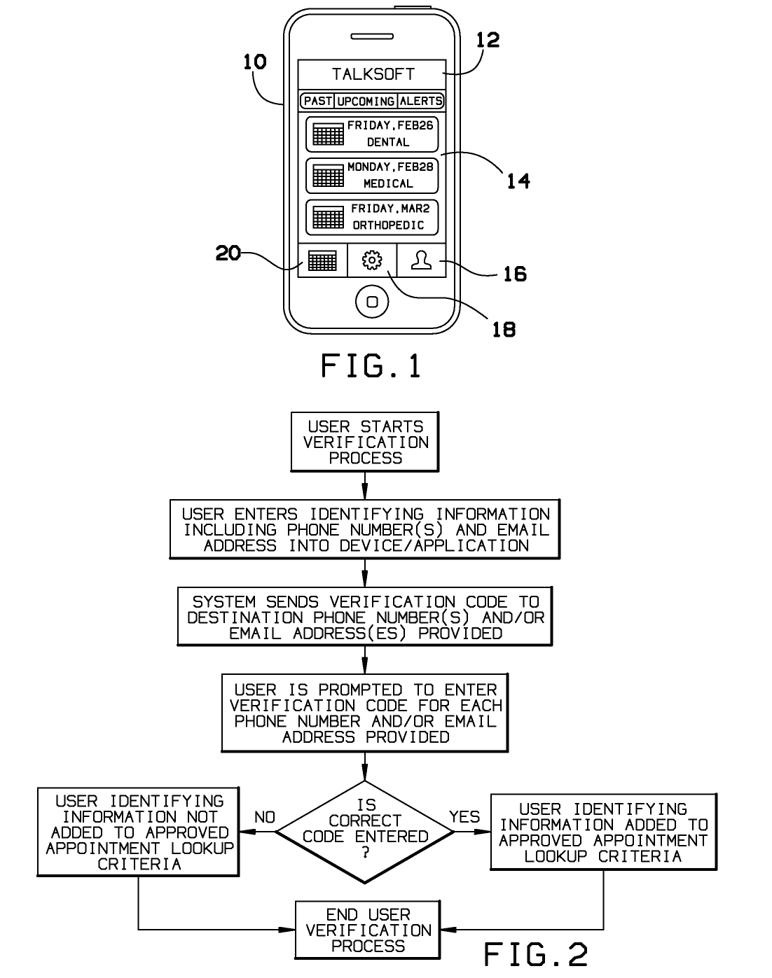

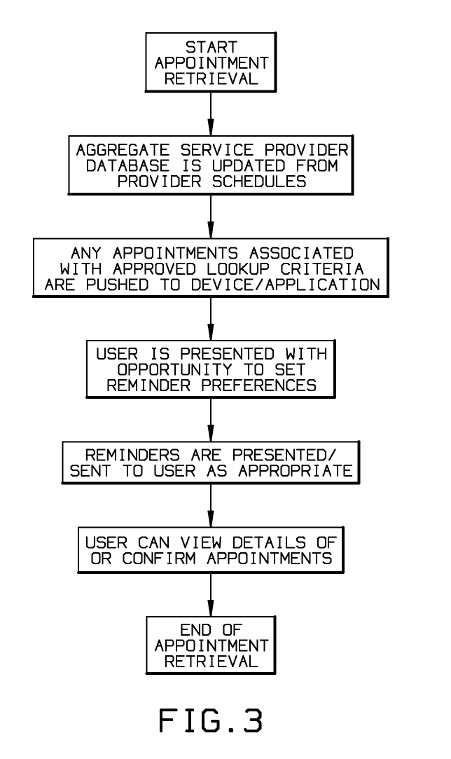

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Referring now to the figures, the following reference numbers may refer to elements of the invention:

10: is the mobile device.

12: is the top banner display.

14: is the scrolling appointment display.

16: is the contacts information button.

18: is the preferences button.

20: is the appointment button.

One embodiment of the present invention gives the ability to the user to look up, obtain information about, and respond to their appointment reminders from one or more service providers at their convenience, in a single application view. The user interface is robust, mobile-friendly, and facilitates rich bi-directional communication between the consumer and the business.

One embodiment of the present invention securely locates appointment records associated with an individual (the user) and one or more of their service providers by searching a consolidated database, presents the appointment information to the user in an interactive and useful manner, and facilitates communication between the user and the appointment provider, including but not limited to confirmation status for these appointments.

As used herein, the word “appointment” may also refer to any kind of time- or date-based obligation or alert, such as a payment due or annual doctor visit reminder, etc.

One embodiment of the present invention may include one or more of the following elements and/or method steps:

The user provides a computer, processor, or mobile device, such as an iPhone™, iPad™, or Android™ device.

The user enters identifying information, as it might be known to local service provider(s), such as doctors' offices, home phone, cell phone, and email address(es).

The system ensures that the user owns these contact methods by sending and verifying a validation code or other means of validating contact information.

At any time prior to or after installation of the mobile app, appointment information may be electronically collected from participating service providers, aggregated, and indexed by any associated phone number(s) and e-mail address(es) and/or other contact or identifying information.

Upon successful validation, or at any time thereafter, the system may send any appointments associated with those validated contact methods to the mobile device.

At any time, the user may set preferences on how they would like to be reminded, e.g., via mobile app, text, phone, email, or combination thereof.

When appointments are pending, at the user's convenience, the user can view information about and/or confirm the appointment or request rescheduling by pressing a button.

Reminders may be sent to the recipient according to their preferences and those of the service provider.

Any confirmation or reschedule request obtained via any means (app, email, text, phone, etc.) may be stored and made available to the service provider via a separate system.

According to one embodiment of the present invention, service providers will individually subscribe to a service which enables regular transmission of their appointment data to an aggregate data store. This information then becomes available to mobile users via the present invention. After installation of the application (“app”), the user provides phone number(s) and/or e-mail address(es) (which may also be known as contact information and/or “destinations”) with which they claim to be associated.

The app may send a randomized verification code to those destinations. If the user does in fact have access to those destinations, they will be able to read and enter the verification code into the app to confirm their ownership of said destinations, effectively verifying those contact methods. This verification mechanism allows utilization of those destinations in at least two ways:

Searching for appointments in the aggregate data store, for display in the mobile app; and

As endpoints for reminders for those appointments.

According to one embodiment of making the present invention, one may first develop a communication link between the service provider's database and the central (aggregate) data store, enabling central storage of all appointment information. Then one would provide a software or mobile application and server component that perform the steps described herein.

Another possible resource that could improve the invention would be access to additional source(s) of appointment data. Entering and verifying contact information is important in order to locate appointments. Adding/verifying (and collecting in the data store) alternate identifying information may help in maximizing the search capabilities. A different mechanism for collecting and/or verifying contact information (such as if this could be provided by and/or performed by the device platform itself) may enhance the process by reducing the amount of data input by the user.

According to one embodiment of using the present invention, a business (service provider) may subscribe to the service, thereby enabling appointment information to be aggregated, and also allowing users to obtain the mobile app and be connected with and informed of the details of their appointments.

While this invention may be used to communicate appointment information to a subscriber, other types of information could be communicated via the same channel, such as personalized alerts about service that is due, changes in schedule or location, special instructions or information relating to the service being provided by the service provider, etc., from the service provider(s) that are providing data to the system. Use of this invention need not be limited to medical or dental appointments -- other industries could utilize this technology as well.

In one aspect of the present invention, a system for consolidating appointment information comprises: a machine; and a program product comprising machine-readable program code for causing, when executed, the machine to perform the following process steps: storing appointment information for a plurality of appointments, each appointment corresponding to at least one contact destination of a user. The storing may occur in a separate hard drive, storage device, server, etc.. The information may be for one or many users, each having lots of appointments to consolidate. Each appointment may correspond to one or more of a plurality of contacts or contact destinations. For example, one appointment may be made with a user's phone number, while another is made with the user's email address. To consolidate them, the system should combine the two (or more contact destinations) by sending the user a verification via both (or all) contact destinations and requesting verification. The system may or may not correlate all the user's contact destinations to one user; if it does not, then the user may simply enter a preference for each verification email/communication received. For example, if appointment A (which corresponds to the user's email) and appointment B (which corresponds to the user's phone number) correspond to the same user, he may simply reply to two verification requests, one to each contact destination, and may set up (as a preference) a reminder for both appointments A and B as the same, such as to be reminded by calling the user at a given phone number (which may be different from the number associated with appointment B), or by emailing, texting, and so forth.

The system may be configured to perform additional steps: receiving a request from the user to consolidate the appointment information; sending a verification request to the user via the at least one contact destination; receiving a verification confirmation from the user regarding the at least one contact destination; receiving from the user a preference regarding appointment reminders; and reminding the user of each of the plurality of appointments according to the preference.

In one aspect, the system further comprises a mobile device (such as an iPhone™, Android™ device, etc., or any processor) connected via a wireless network (such as via WiFi™ connection to the Internet) to the machine. In one aspect, the mobile device is configured to display reminders of the plurality of appointments according to the preference. In one aspect, the mobile device is configured to display a plurality of possible preferences from which the user may select the preference, such as allowing reminders via email, phone call, viewing on the mobile device via application, and so forth.

In one aspect, the program code further causes the machine to store appointment information for a plurality of appointments for a plurality of users. In one aspect, the program code further causes the machine to receive a reschedule request from the user. In one aspect, the program code further causes the machine to receive an appointment confirmation from the user. In one aspect, the at least one contact destination of the user comprises a phone number. In one aspect, the at least one contact destination of the user comprises an email address.

In one aspect, at least one appointment corresponds to a first contact destination of the user, the first contact destination comprising a phone number, and wherein at least one appointment corresponds to a second contact destination of the user, the second contact destination comprising an email address. In one aspect, the program code further causes the machine to consolidate the appointment information, whereby the reminding comprises reminding the user of each of the plurality of appointments according to the preference and irrespective of to which contact destination each appointment corresponds. In one aspect, the appointment information comprises information authorized by the user regarding dates and times of meetings with other people. In one aspect, the preference comprises a preference for being reminded via text message. In one aspect, the preference comprises a preference for being reminded via phone call.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

What is claimed is:

1. A system for consolidating appointment information, comprising:
a machine; and
a program product comprising machine-readable program code for causing, when executed, the machine to perform the following process steps:
storing appointment information for a plurality of appointments, each appointment corresponding to at least one contact destination of a user;
receiving a request from the user to consolidate the appointment information;
sending a verification request to the user via the at least one contact destination;
receiving a verification confirmation from the user regarding the at least one contact destination;
receiving from the user a preference regarding appointment reminders; and
reminding the user of each of the plurality of appointments according to the preference.

2. The system as claimed in claim 1, further comprising a mobile device connected via a wireless network to the machine.

3. The system as claimed in claim 2, wherein the mobile device is configured to display reminders of the plurality of appointments according to the preference.

4. The system as claimed in claim 2, wherein the mobile device is configured to display a plurality of possible preferences from which the user may select the preference.

5. The system as claimed in claim 1, wherein the program code further causes the machine to store appointment information for a plurality of appointments for a plurality of users.

6. The system as claimed in claim 1, wherein the program code further causes the machine to receive a reschedule request from the user.

7. The system as claimed in claim 1, wherein the program code further causes the machine to receive an appointment confirmation from the user.

8. The system as claimed in claim 1, wherein the at least one contact destination of the user comprises a phone number.

9. The system as claimed in claim 1, wherein the at least one contact destination of the user comprises an email address.

10. The system as claimed in claim 1, wherein at least one appointment corresponds to a first contact destination of the user, the first contact destination comprising a phone number, and wherein at least one appointment corresponds to a second contact destination of the user, the second contact destination comprising an email address.

11. The system as claimed in claim 10, wherein the program code further causes the machine to consolidate the appointment information, whereby the reminding comprises reminding the user of each of the plurality of appointments according to the preference and irrespective of to which contact destination each appointment corresponds.

12. The system as claimed in claim 1, wherein the appointment information comprises information authorized by the user regarding dates and times of meetings with other people.

13. The system as claimed in claim 1, wherein the preference comprises a preference for being reminded via text message.

14. The system as claimed in claim 1, wherein the preference comprises a preference for being reminded via phone call.
